(19) United States
(12) Patent Application Publication
(10) Pub. No.: US 2022/0264333 A1
(43) Pub. Date: Aug. 18, 2022

(54) PROTECTION ZONES FOR USE IN CENTRALIZED OR CLOUD RADIO ACCESS NETWORK (C-RAN)

(71) Applicant: CommScope Technologies LLC, Hickory, NC (US)

(72) Inventors: Stuart D. Sandberg, Acton, MA (US); Balaji B Raghothaman, Chester Springs, PA (US); Irfaan Ahamed Salahuddeen, Acton, MA (US)

(73) Assignee: CommScope Technologies LLC, Hickory, NC (US)

(21) Appl. No.: 17/673,160

(22) Filed: Feb. 16, 2022

Related U.S. Application Data
(60) Provisional application No. 63/150,429, filed on Feb. 17, 2021.

(51) Int. Cl. H04W 24/02; H04W 8/20; H04W 24/08

(52) U.S. Cl. CPC H04W 24/02; H04W 24/08; H04W 8/20

(57) ABSTRACT

In one embodiment, the following is determined for each UE served by a radio access network: a first set of remote units from which to wirelessly transmit user data to that UE and a second set of remote units that are not used to wirelessly transmit user data to any other UE while user data is being wirelessly transmitted to that UE. The second set for each UE includes the first set of remote units for that UE. Downlink fronthaul data for each UE is transmitted over the fronthaul to only the remote units included in the first set for that UE. The first set of remote units for each UE is used to wirelessly transmit user data to that UE, where no remote unit included in the second set for that UE is used to wirelessly transmit user data while wirelessly transmitting to that UE.

### CROSS-REFERENCE TO RELATED APPLICATIONS

This application claims the benefit of U.S. Provisional Patent Application Ser. No. 63/150,429, filed on Feb. 17, 2021, which is hereby incorporated herein by reference in its entirety.

### BACKGROUND

A centralized or cloud radio access network (C-RAN) is one way to implement base station functionality. Typically, for each cell implemented by a C-RAN, a single baseband unit (BBU) interacts with multiple remote units (also referred to here as “radio points” or “RPs”) in order to provide wireless service to various items of user equipment (UEs). The multiple remote units are typically located remotely from each other (that is, the multiple remote units are not co-located). The BBU is communicatively coupled to the remote units over a fronthaul network.

Downlink user data is scheduled for wireless transmission to each UE. When a C-RAN is used, the downlink user data for a UE can be wirelessly transmitted from a set of one or more remote units of the C-RAN. This set of remote units is also referred to here as the “simulcast zone” for the UE. The respective simulcast zone can vary from UE to UE. The corresponding downlink fronthaul data for each UE must be communicated from the BBU over the fronthaul network to each remote unit in that UE's simulcast zone.

In some embodiments, the C-RAN is configured to support frequency reuse. As used here, “downlink frequency reuse” refers to situations where separate downlink user data intended for different UEs is simultaneously wirelessly transmitted to the UEs using the same physical resource blocks (PRBs) for the same cell. For those PRBs where downlink frequency reuse is used, each of the multiple reuse UEs is served by a different subset of the RUs, where no RU is used to serve more than one UE for those reused PRBs. That is, for the reused PRBs, the simulcast zone for each of the multiple reuse UEs does not include any RU that is included in the simulcast zone of any of the other reuse UEs. Typically, these situations arise where the reuse UEs are sufficiently physically separated from each other so that the co-channel interference resulting from the different wireless downlink transmissions is sufficiently low (that is, where there is sufficient radio frequency (RF) isolation).

One way that downlink fronthaul data can be communicated over the fronthaul network from the BBU to the remote units in a UE's simulcast zone is to use broadcast transmission. A broadcast transmission causes the downlink fronthaul data to be transmitted over the fronthaul network to all of the remote units in the C-RAN in connection with that transmission. Some types of fronthaul networks (for example, switched Ethernet fronthaul networks) include native support for broadcast transmission that can reduce the amount of bandwidth used over at least some of the communications links in the fronthaul network (for example, in the Ethernet links used to couple the BBU to the rest of a switched Ethernet fronthaul network). Because a broadcast transmission causes the downlink fronthaul data to be transmitted to all of the remote units in the C-RAN, a BBU can use a single broadcast transmission in order to transmit a given packet (or other unit) of downlink fronthaul data to all of the remote units in the simulcast zone of a UE.

Another way that downlink fronthaul data can be communicated over the fronthaul network from the BBU to the remote units in a UE's simulcast zone is to use unicast transmission. Each unicast transmission causes downlink fronthaul data to be transmitted over the fronthaul network to a single one of the remote units in the C-RAN in connection with that transmission. Because of this, in order to transmit a given packet (or other unit) of downlink fronthaul data over the fronthaul network from the BBU to each of the remote units in the simulcast zone of a UE, the BBU needs to make a separate unicast transmission for each such remote unit. However, using unicast transmission in this way can increase the amount of bandwidth used over at least some of the communications links in the fronthaul network (for example, in the Ethernet links used to couple the BBU to the rest of a switched Ethernet fronthaul network). This increase in bandwidth resulting from using unicast transmission typically scales by a factor approximately equal to the average simulcast zone size. This increase in bandwidth resulting from using unicast transmission is of special concern when downlink frequency reuse is used, since downlink fronthaul data for the multiple reuse UEs needs to be communicated over the fronthaul network from the BBU to all of the remote units in the simulcast zones of all of the multiple reuse UEs.

### SUMMARY

One embodiment is directed to a system comprising a distributed unit to communicatively couple the system to a core network and a plurality of remote units to wirelessly transmit and receive radio frequency signals to and from user equipment (UE) using a wireless interface. Each of the remote units is associated with a respective set of antennas. The distributed unit is communicatively coupled to the plurality of remote units over a fronthaul network. The distributed unit is configured to do the following for each UE: determine a respective first set of remote units from which to wirelessly transmit user data to that UE; determine a respective second set of remote units that are not used to wirelessly transmit user data to any other UE while user data is being wirelessly transmitted to that UE, where the respective second set of remote units for that UE includes the respective first set of remote units for that UE; transmit respective downlink fronthaul data for that UE over the fronthaul network to only the remote units included in the respective first set of remote units for that UE; and wirelessly transmit respective user data to that UE using the respective first set of remote units for that UE. No remote unit included in the respective second set of remote units for that UE is used to wirelessly transmit user data while wirelessly transmitting to that UE.

Another embodiment is directed to a method of communicating downlink fronthaul data in a system comprising a distributed unit to communicatively couple the system to a core network and a plurality of remote units to wirelessly transmit and receive radio frequency signals to and from user equipment (UE) using a wireless interface. Each of the remote units is associated with a respective set of antennas. The distributed unit is communicatively coupled to the plurality of remote units over a fronthaul network. The method comprises doing the following for each UE: determining a respective first set of remote units from which to wirelessly transmit user data to that UE; determining a respective second set of remote units that are not used to wirelessly transmit user data to any other UE while user data is being wirelessly transmitted to that UE, wherein the respective second set of remote units for that UE includes the first set of remote units for that UE; transmitting respective downlink fronthaul data for that UE over the fronthaul network to only the remote units included in the respective first set of remote units for that UE; and wirelessly transmitting respective user data to that UE using the respective first set of remote units for that UE, wherein no remote unit included in the respective second set of remote units for that UE is used to wirelessly transmit user data while wirelessly transmitting to that UE.

The details of various embodiments are set forth in the accompanying drawings and the description below. Other features and advantages will become apparent from the description, the drawings, and the claims.

### DRAWINGS

FIG. 1 is a block diagram illustrating one exemplary embodiment of a radio access network (RAN) system in which the protection zones described below can be used.

FIG. 2 comprises a high-level flowchart illustrating one exemplary embodiment of a method of communicating using a radio access network.

Like reference numbers and designations in the various drawings indicate like elements.

### DETAILED DESCRIPTION

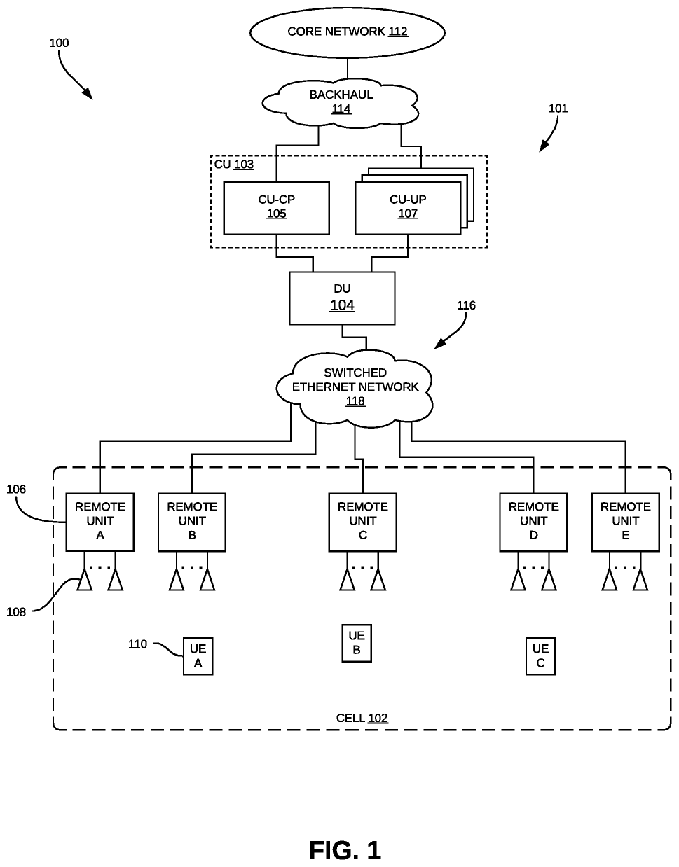

FIG. 1 is a block diagram illustrating one exemplary embodiment of a radio access network (RAN) system 100 in which the protection zones described below can be used. The RAN system 100 shown in FIG. 1 implements at least one base station 101 to serve at least one cell 102. The RAN system 100 can also be referred to here as a “base station system.”

In the exemplary embodiment shown in FIG. 1, the system 100 is implemented at least in part using a centralized or cloud RAN (C-RAN) architecture in which each base station 101 is partitioned into one or more central unit entities (CUs) 103, one or more distributed unit entities (DUs) 104, and one or more radio units (RUs) 106. In such a configuration, each CU 103 implements Layer 3 and non-time critical Layer 2 functions for the base station 101. In the embodiment shown in FIG. 1, each CU 103 is further partitioned into one or more control-plane entities 105 and one or more user-plane entities 107 that handle the control-plane and user-plane processing of the CU 103, respectively. Each such control-plane CU entity 105 is also referred to as a “CU-CP” 105, and each such user-plane CU entity 107 is also referred to as a “CU-UP” 107. Also, in such a configuration, each DU 104 is configured to implement the time critical Layer 2 functions and at least some of the Layer 1 functions for the base station 101. In this example, each RU 106 is configured to implement the physical layer functions for the base station 101 that are not implemented in the DU 104 as well as the RF interface.

Also, each RU 106 includes or is coupled to one or more antennas 108 via which downlink RF signals are radiated to various items of user equipment (UE) 110 and via which uplink RF signals transmitted by UEs 110 are received.

Although FIG. 1 (and the description set forth below more generally) is described in the context of a 5G embodiment in which each logical base station entity 101 is partitioned into a CU 103, a DU 104, and RUs 106 and, for at least some of the physical channels, some physical-layer processing is performed in each DUs 106 with the remaining physical-layer processing being performed in the RUs 106, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

In one implementation, each RU 106 is remotely located from each DU 104 serving it. Also, in such an implementation, at least one of the RUs 106 is remotely located from at least one other RU 106 serving that cell 102. In another implementation, at least some of the RUs 106 are co-located with each other, where the respective sets of antennas 108 associated with the RUs 106 are directed to transmit and receive signals from different areas.

The RAN system 100 can be implemented in accordance with one or more public standards and specifications. For example, the RAN system 100 can be implemented using a RAN architecture and/or RAN fronthaul interfaces defined by the O-RAN Alliance in order to provide 4G LTE and/or 5G wireless service. (“O-RAN” stands for Open Radio Access Network.) In such an O-RAN example, the DU 104 and RUs 106 can be implemented as O-RAN distributed units and O-RAN remote units, respectively, in accordance with the O-RAN specifications. The RAN system 100 can be implemented in other ways.

The system 100 is coupled to a core network 112 of the associated wireless network operator over an appropriate backhaul 114 (such as the Internet). Also, each DU 104 is communicatively coupled to the RUs 106 served by it using a fronthaul 116. Each of the DU 104 and RUs 106 include one or more network interfaces (not shown) in order to enable the DU 104 and RUs 106 to communicate over the fronthaul 116.

In one implementation, the fronthaul 116 that communicatively couples the DU 104 to the RUs 106 is implemented using a switched ETHERNET network 118. In such an implementation, each DU 104 and RUs 106 includes one or more ETHERNET interfaces for communicating over the switched ETHERNET network 118 used for the fronthaul 116. In one implementation, an O-RAN fronthaul interface is used for communication between the DU 110 and the RUs 112 over the fronthaul network 120. In another implementation, a proprietary fronthaul interface is used that employs a so-called “functional split 7-2” for at least some of the physical channels (for example, for the PDSCH and PUSCH) and a different functional split for at last some of the other physical channels (for example, using a functional split 6 for the PRACH and SRS) is used. However, it is to be understood that the fronthaul between each DU 104 and the RUs 106 served by it can be implemented in other ways.

Each CU 103, DU 104, and RU 106 (and the functionality described here as being included therein), as well as the system 100 more generally, and any of the specific features described here as being implemented by any of the foregoing, can be implemented in hardware, software, or combinations of hardware and software, and the various implementations (whether hardware, software, or combinations of hardware and software) can also be referred to generally as “circuitry” or a “circuit” or “circuits” configured to implement at least some of the associated functionality. When implemented in software, such software can be implemented in software or firmware executing on one or more suitable programmable processors or configuring a programmable device (for example, processors or devices included in or used to implement special-purpose hardware, general-purpose hardware, and/or a virtual platform). Such hardware or software (or portions thereof) can be implemented in other ways (for example, in an application specific integrated circuit (ASIC), etc.). Also, the RF functionality can be implemented using one or more RF integrated circuits (RFICs) and/or discrete components. Each CU 103, DU 104, RU 106, and the system 100 more generally, can be implemented in other ways.

The C-RAN 100 is configured so that downlink user data can be wirelessly transmitted from one or more remote units 106 of the C-RAN 100. This set of remote units is also referred to here as the “simulcast zone” for the UE 110. The respective simulcast zone can vary from UE 110 to UE 110. The corresponding downlink fronthaul data for each UE 110 must be communicated from the DU 104 over the fronthaul network 116 to each remote unit 106 in that UE's simulcast zone. The “size” of a simulcast zone refers to the number of remote units 106 that are included in that simulcast zone. In general, the simulcast zone for a UE 110 includes those remote units 106 that have the “best” or “strongest” signal reception characteristics for that UE 110, assuming those remote units 106 have sufficient capacity.

In one exemplary embodiment, the simulcast zone for each UE 110 can be determined by the serving DU 104 using a “signature vector” (SV) associated with that UE 110. Each element of the signature vector corresponds to one of the remote units 106 used to serve the cell 102 and comprises one or more numerical values associated with the signal transmission or reception characteristics for that UE 110.

The elements of the signature vector for each UE 110 can be determined based on uplink transmissions from the UE 110. Such an approach is based on the assumption that the relative signal reception metrics determined using such uplink transmissions are representative of which remote units 106 the UE 110 will have the best or strongest signal reception characteristics for downlink transmissions made from those remote units 106 and are sufficiently representative for the purpose of determining the simulcast zone for the UE 110. For example, the signature vector can be determined based on received power measurements made at each of the remote units 106 serving the cell 102 for one or more uplink transmissions from the UE 110 (for example, Physical Random Access Channel (PRACH) and Sounding Reference Signals (SRS) transmissions). More specifically, each remote unit 106 serving the cell 102 will receive those uplink transmissions and can measure or otherwise determine a signal reception metric indicative of the power level of the transmissions received by that remote unit 106 from the UE 110. One example of such a signal reception metric is a signal-to-noise plus interference ratio (SNIR). The signature vector can be updated over the course of a UE's connection to the cell 102 (for example, based on SRS transmissions from the UE 110.

One way that the respective signature vector determined for a given UE 110 can be used to determine the respective simulcast zone for that UE 110 is by using the signature vector to calculate a “total simulcast zone (SZ) power” and a “total available power” for that UE 110. The total simulcast zone power for a given UE 110 is the sum of the respective signal reception metrics determined for that UE 110 corresponding to the remote units 106 that are currently included in the simulcast zone of that UE 110. The “total available power” for the UE 110 is the sum of the signal reception metrics determined for that UE 110 that correspond to all of the remote units 106. The simulcast zone for a UE 110 can be determined by including enough remote units 106 in the simulcast zone for the UE 110 so that the total simulcast zone power for the UE 110 is within a threshold amount of the total available power for the UE 110. More specially, a respective simulcast zone fora UE 110 can be determined by starting with an empty simulcast zone for that UE 110, sorting the remote units 106 based on the respective corresponding signal reception metrics determined for that UE 110 in descending order from strongest power to weakest power, and adding, to the simulcast zone for that UE 110, successive remote units 106 (according to the resulting sorted descending order) until the total simulcast zone power calculated for that UE 110 is within a threshold amount of the respective total available power calculated for that UE 110 or until the number of remote units 106 included in the respective simulcast zone for that UE is equal to a predetermined maximum value (also referred to here as the “simulcast zone cap” |SZ|_{cap}). That is, the size of the simulcast zone is limited to the simulcast zone cap |SZ|_{cap}.

The C-RAN 100 is configured to support frequency reuse. As noted above, “downlink frequency reuse” refers to situations where separate downlink user data intended for different UEs 110 is simultaneously wirelessly transmitted to the UEs 110 using the same physical resource blocks (PRBs) for the same cell 102. Such reuse UEs 110 are also referred to here as being “in reuse” with each other. For those PRBs where downlink frequency reuse is used, each of the multiple reuse UEs 110 is served by a different subset of the RUs 106, where no RU 106 is used to serve more than one UE 110 for those reused PRBs. That is, for the reused PRBs, the simulcast zone for each of the multiple reuse UEs 110 does not include any RU 106 that is included in the simulcast zone of any of the other reuse UEs 110. Typically, these situations arise where the reuse UEs 110 are sufficiently physically separated from each other so that the co-channel interference resulting from the different wireless downlink transmissions is sufficiently low (that is, where there is sufficient RF isolation).

As noted above, one way that downlink fronthaul data can be communicated over the fronthaul network 116 from the DU 104 to the remote units 106 included in a UE's simulcast zone is to use unicast transmission. Each unicast transmission causes downlink fronthaul data to be transmitted over the fronthaul network 116 to a single one of the remote units 106 in the C-RAN 100 in connection with that transmission. Because of this, in order to transmit a given packet (or other unit) of downlink fronthaul data over the fronthaul network 116 from the DU 104 to each of the remote units 106 in the simulcast zone of a UE 110, the DU 104 needs to make a separate unicast transmission for each such remote unit 106.

As noted above, using unicast transmission in this way can increase the amount of bandwidth used over at least some of the communications links in the fronthaul network 116 (for example, in the Ethernet links used to couple the DU 104 to the rest of a switched Ethernet fronthaul network 118). This increase in bandwidth resulting from using unicast transmission typically scales by a factor approximately equal to the average simulcast zone size |SZ|.

Limiting the size of each UE's simulcast zone to a predetermined maximum value (the simulcast zone cap |SZ|_{cap}) is one way to reduce the amount of bandwidth used over at least some of the communications links in the fronthaul network 116 when unicast transmission is used, while at the same time tending to increase the number of opportunities in which downlink frequency reuse can be used.

The simulcast zone cap |SZ|_{cap} must be selected judiciously though—spectral efficiency for a given UE 110 generally decreases when decreasing the size of the simulcast cap |SZ|_{cap}. The choice of the simulcast cap |SZ|_{cap} involves a trade off between the throughput supported for wireless communication with a UE 110 and the amount of fronthaul bandwidth that is required.

The benefit to a given UE 110 for a relatively large simulcast zone is captured mainly in the greater protection it offers in preventing the remote units 106 included in the simulcast zone for that given UE 110 from being used to wirelessly transmit to one or more other UEs 110 that are in reuse with that given UE 110. The additional benefit of relatively greater signal power for a given UE 110 is generally less significant in comparison to the reduction in interference resulting from preventing the remote units 106 included in the simulcast zone for that given UE 110 from being used to wirelessly transmit to other UEs 110. Therefore, to mitigate significantly the loss of spectral efficiency to a UE 110 from capping the size of the simulcast zone, a “protection zone” (PZ) can be defined and used for each UE 110.

The protection zone for a given UE 110 contains the remote units 106 that are in the simulcast zone of that UE 110 as well as other remote units 106 having relatively good or strong signal reception characteristics for that UE 110 (which, for example, can be determined using the signature vector for the UE 110). That is, the protection zone for a given UE 110 includes those remote units 106 to which the UE 110 would have relatively high interference sensitivity if used for transmitting to a different UE 110.

The protection zone for a given UE 110 is used during scheduling to prevent transmissions to any other UEs 110 in reuse with that given UE 110 using any remote units 106 included in the protection zone of that given UE 110. A predetermined maximum value (referred to here as the “protection zone cap” |PZ|_{cap}) can be imposed on the size of each UE's protection zone. Limiting the size of each UE's protection zone to the |PZ|_{cap} is one way to limit the impact of the use of protection zones on the number of the opportunities in which downlink frequency reuse can be employed. In general, using protection zones in this manner will tend to reduce the amount of bandwidth used over at least some of the communications links in the fronthaul network 116 when unicast transmission is used, while at the same tending to increase the number of opportunities in which downlink frequency reuse can be used.

The respective signature vector for a given UE 110 can be used to determine the protection zone for each UE 110. Each UE 110 has an associated respective “remaining available power” that can be calculated by summing the signal reception metrics determined for that UE 110 corresponding to the remote units 106 not already included in the protection zone for that UE 110. The remote units 106 can be sorted based on the respective corresponding signal reception metrics included in the signature vector of that UE 110 in descending order from strongest power to weakest power. Then, starting with an empty protection zone, the remote units 106 included in the simulcast zone for that UE 110 can be added to the protection zone and, from the remaining remote units 106 not included in the protection zone, successive remotes 106 can be added to the protection zone in the descending order until the ratio of the respective total simulcast zone power for the UE 110 and the respective remaining available power for the UE 110 exceeds a predetermined threshold value (referred to here as the “signal-to-interference (SIR) threshold”) or until the total number of remote units 106 included in the respective protection zone for that UE 110 equals the protection zone cap |PZ|_{cap}. In one implementation, the SIR threshold corresponds to a value that identifies remote units 106 to which the UE 110 would have relatively high interference sensitivity if used for wirelessly transmitting to a different UE 110.

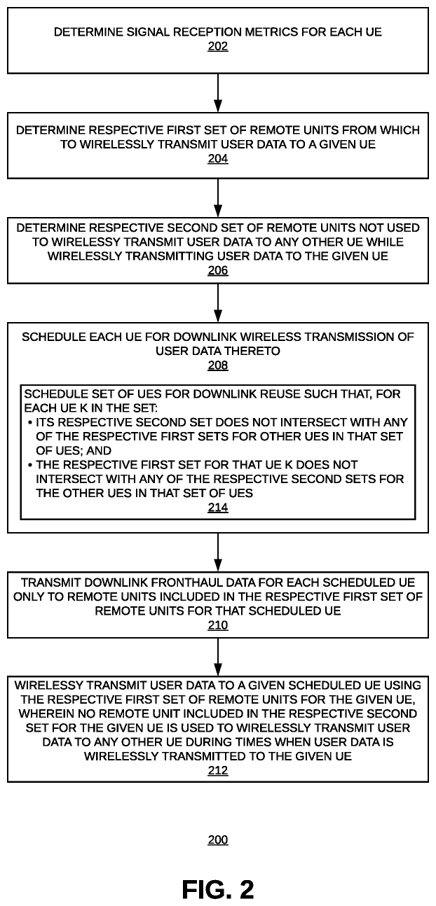

One example of how protection zones can be used is described below in connection with FIG. 2.

FIG. 2 comprises a high-level flowchart illustrating one exemplary embodiment of a method 200 of communicating using a radio access network. The embodiment of method 200 shown in FIG. 2 is described here as being implemented using the C-RAN 100 of FIG. 1 (though it is to be understood that other embodiments can be implemented in other ways).

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner). Also, most standard exception handling is not described for ease of explanation; however, it is to be understood that method 200 can and typically would include such exception handling.

Method 200 can be performed by the distributed unit 104 and the remote units 106 of the C-RAN 100.

Method 200 comprises determining signal reception characteristics for each UE 110 (block 202). The signal reception characteristics for each UE 110 can be determined on a remote-unit-by-remote-unit basis (that is, for each UE 110, signal reception characteristics can be determined for that UE 110 for each remote unit 106 serving the cell 102). These signal reception characteristics can be determined at each remote unit 106 based on one or more uplink transmissions made by each UE 110 and/or determined at each UE 110 based on one or more downlink transmissions made from each remote unit 106 to the UE 110. For example, in the exemplary embodiment described here in connection with FIG. 1, the signal reception characteristics determined for each UE 110 comprise a signature vector that is determined for each UE 110 as described above and the signal reception characteristics for each UE 110 are determined by updating the signature vector for each UE 110.

Method 200 further comprises determining a first set of remote units 106 from which to wirelessly transmit user data to a given UE 110 (block 204) and determining a second set of remote units 106 not used to wirelessly transmit user data to any other UE 110 while user data is being wirelessly transmitted to the given UE 110 (block 206). These determinations are done separately for each UE 110 so that each UE 110 has its own respective first and second sets of remote units 106. For example, in the exemplary embodiment described here in connection with FIG. 1, the respective first set of remote units 106 from which to wirelessly transmit user data to a given UE 110 comprises the simulcast zone referred to above and the second set of remote units 106 that are not used to wirelessly transmit user data to any other UE 110 while user data is being wirelessly transmitted to the given UE 110 comprises the protection zone referred to above. In such an embodiment, the respective second set of remote units 106 (that is, the protection zone) for a given UE 110 includes the respective first set of remote units 106 (that is, the simulcast zone) for the given UE 110 as well any other remote units 106 to which the given UE 110 would have relatively high interference sensitivity if used for wirelessly transmitting to a different UE 110. The remote units 106 that are included in the protection zone for a UE 110 that are not included in the simulcast zone for the UE 110 are referred to here as the “PZ-only remote units 106” for the UE 110.

For example, in the exemplary embodiment described here in connection with FIG. 1 where the signal reception characteristics determined for each UE 110 comprise a signature vector that is determined for each UE 110, one way that the signature vector for a given UE 110 can be used to determine the simulcast zone for that UE 110 is by including enough remote units 106 in the simulcast zone so that the total SZ power for the UE 110 is within a threshold amount of the total available power for the UE 110. To do this, the elements of the signature vector for a given UE 110 can be sorted in descending order (from strongest to weakest) and then, starting with an empty simulcast zone for the UE 110, successive remote units 106 can be added to the simulcast zone for the UE 110 in the resulting descending order until the total SZ power for the UE 110 is within the threshold amount of the total available power for the UE 110 or until the total number of remote units 106 included in the simulcast zone for the UE 110 is equal to the simulcast zone cap |SZ|_{cap}. In this example, one way that the signature vector for a given UE 110 can be used to determine the protection zone for that UE 110 is by sorting the remote units 106 based on the respective corresponding signal reception metrics included in the signature vector of that UE 110 in descending order from strongest power to weakest power. Then, starting with an empty protection zone, the remotes unit 106 included in the simulcast zone for each UE 110 can be added to the protection zone and, from the remaining remote units 106 not included in the protection zone, successive remotes unit 106 can be added to the protection zone in the descending order until the ratio of the respective total simulcast zone power for the UE 110 and the respective remaining available power for the UE 110 exceeds the SIR threshold or until the total number of remote units 106 included in the respective protection zone for that UE 110 equals the protection zone cap |PZ|_{cap}.

Method 200 further comprises scheduling each UE 110 for downlink wireless transmission of user data thereto (block 208) and transmitting respective downlink fronthaul data for each scheduled UE 110 to only the remote units 106 included in the respective first set of remote units 106 for each such scheduled UE 110 (block 210). The downlink fronthaul data is transmitted over the fronthaul network 116 from the distributed unit 104 serving the cell 102. The downlink fronthaul data for each such scheduled UE 110 is not transmitted to any other remote units 106, including any remote units 106 that are both in the second set of remote units 106 for that UE 110 and not in the first set of remote units 106 (that is, the downlink fronthaul data for each such scheduled UE 110 is not transmitted to any PZ-only remote units 106 for that UE 110).

In some implementations, for each scheduled UE 110, the respective downlink fronthaul data can be transmitted to only the remote units 106 included in the respective first set of remote units 106 for that UE 110 using unicast transmission. In the particular embodiments described here, where the fronthaul network 116 is implemented using a switched Ethernet network 118, Ethernet and/or Internet Protocols (IP) features can be used for implementing unicast transmission of downlink fronthaul data over the switched Ethernet network 118 to the remote units 106 in the simulcast zone for each UE 110. It is to be understood, however, that in other implementations, other ways of transmitting the respective downlink fronthaul data can be used (for example, multicast transmission).

Method 200 further comprises wirelessly transmitting respective user data to a given scheduled UE 110 using the respective first set of remote units 106 for the given UE 110, wherein no remote unit 106 included in the respective second set of remote units 106 for that UE 110 is used to wirelessly transmit user data to any other UE 110 during the times when user data is wirelessly transmitted to the given UE 110 (block 212). That is, respective user data is wireless transmitted to a given scheduled UE 110 using the remote units 106 in the respective simulcast zone for the given UE 110, where no remote unit 106 included in the respective protection zone for the given UE 110 is used to wirelessly transmit user data to any other UE 110 during the times when user data is wirelessly transmitted to the given UE 110.

In the particular embodiment shown in FIG. 2, scheduling each UE 110 for downlink wireless transmission thereto comprises, among other things, scheduling a set of UEs 110 for downlink frequency reuse such that, for each UE k in the set, (1) its respective second set of remote units 106 (that is, its respective PZ) does not intersect with any of the respective first sets of remote units 106 (that is, the respective SZs) for the other UEs 110 in that set and (2) the respective first set of remote units 106 (that is, the respective SZ) for that UE k does not intersect with any of the respective second sets of remote units 106 (that is, any of the respective PZs) for the other UEs 110 in that set (block 214). That is, the system 100 is configured to permit different downlink user data intended for each of multiple UEs 110 to be simultaneously wirelessly transmitted to the multiple UEs 110 during one or more physical resource blocks (that is, to be put into downlink frequency reuse) in situations where the respective simulcast zone for each of the multiple UEs 110 does not intersect with the respective protection zone for any other of the multiple UEs 110 and the respective protection zone for each of the multiple UEs 110 does not intersect with the respective simulcast zone for any other of the multiple UEs. A first set of remote units 106 (that is, a simulcast zone) “intersects” with a second set of remote units 106 (that is, a protection zone) if any remote unit 106 is included in both the first set of remote units 106 and the second set of remote units 106 (that is, is included in both the simulcast zone and the protection zone). Likewise, a second set of remote units 106 (that is, a protection zone) “intersects” with a first set of remote units 106 (that is, a simulcast zone) if any remote unit 106 is included in both the second set of remote units 106 and the first set of remote units 106 (that is, is included in both the protection zone and the simulcast zone).

For example, in the example shown in FIG. 1, three UEs 110 are being served by the system 100 using five remote units 106, where the UEs 110 are individually referenced in FIG. 1 as UE A, UE B, and UE C and the remote units 106 are individually referenced in FIG. 1 as remote unit A, remote unit B, remote unit C, remote unit D, and remote unit E. In this example, the signature vectors for UE A, B, and C are updated and used to determine the respective simulcast and protections zones for UE A, B, and C. In this example, the simulcast zone for UE A includes remote units A and B and the protection zone for UE A includes remote units A and B (because they are included in the simulcast zone for UE A) as well as remote unit C. In this example, the simulcast zone for UE B includes remote unit C and the protection zone for UE A includes remote unit C (because it is included in the simulcast zone for UE B) as well as remote units B and D. In this example, the simulcast zone for UE C includes remote units D and E and the protection zone for UE C includes remote units D and E (because they are included in the simulcast zone for UE C) as well as remote unit C.

When UE A is scheduled to have downlink user data wirelessly transmitted to it, unicast transmission is used to transmit downlink fronthaul data for UE A over the fronthaul network 116 to only remote units A and B (the remote units 106 in the simulcast zone for UE A). When UE B is scheduled to have downlink user data wirelessly transmitted to it, unicast transmission is used to transmit downlink fronthaul data for UE B over the fronthaul network 116 to only remote unit C (the remote unit 106 in the simulcast zone for UE B). When UE C is scheduled to have downlink user data wirelessly transmitted to it, unicast transmission is used to transmit downlink fronthaul data for UE C over the fronthaul network 116 to only remote units D and E (the remote units 106 in the simulcast zone for UE C).

Also, in this example, UEs A and C can be scheduled for downlink frequency reuse. This is because the simulcast zone for UE A does not intersect with the protection zone for UE C and the protection zone for UE A does not intersect with the simulcast zone for UE C. However, in this example, UE B cannot be scheduled for downlink frequency reuse with either UE A or UE C. This is because the simulcast zone for UE B intersects with both the protection zone for UE A and the protection zone for UE C (because remote unit C is included in both the simulcast zone for UE B and the protection zones for both UE A and UE C).

By using protection zones and the techniques described above, with appropriate selection of |SZ|_{cap} and |PZ|_{cap}, the increase in the amount of bandwidth used over at least some of the communications links in the fronthaul network resulting from using unicast transmission in a RAN that supports downlink frequency reuse can be mitigated, while still increasing wireless downlink transmission throughput as a result of employing downlink frequency reuse. Indeed, in some situations, the increase in wireless downlink transmission throughput resulting from employing downlink frequency reuse when protection zones are used can exceed the increase that would result without using them.

Other embodiments can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a system comprising: a distributed unit to communicatively couple the system to a core network; and a plurality of remote units to wirelessly transmit and receive radio frequency signals to and from user equipment (UE) using a wireless interface, each of the remote units associated with a respective set of antennas; wherein the distributed unit is communicatively coupled to the plurality of remote units over a fronthaul network; wherein the distributed unit is configured to do the following for each UE: determine a respective first set of remote units from which to wirelessly transmit user data to that UE; determine a respective second set of remote units that are not used to wirelessly transmit user data to any other UE while user data is being wirelessly transmitted to that UE, wherein the respective second set of remote units for that UE includes the respective first set of remote units for that UE; transmit respective downlink fronthaul data for that UE over the fronthaul network to only the remote units included in the respective first set of remote units for that UE; and wirelessly transmit respective user data to that UE using the respective first set of remote units for that UE, wherein no remote unit included in the respective second set of remote units for that UE is used to wirelessly transmit user data while wirelessly transmitting to that UE.

Example 2 includes the system of Example 1, wherein the distributed unit is configured to do the following for each UE: use unicast transmission to transmit the respective downlink fronthaul data for that UE over the fronthaul network to only the remote units included in the respective first set of remote units for that UE.

Example 3 includes the system of any of Examples 1-2, wherein the system is configured to permit respective downlink user data intended for each of multiple UEs to be simultaneously wirelessly transmitted to the multiple UEs during one or more physical resource blocks in situations where: the first set of remote units for each of said multiple UEs does not intersect with the second set of remote units for any other of said multiple UEs; and the second set of remote units for each of said multiple UEs does not intersect with the first set of remote units for any other of said multiple UEs.

Example 4 includes the system of any of Examples 1-3, wherein the respective first set of remote units for a given UE comprises a respective simulcast zone for the given UE and wherein the respective second set of remote units for the given UE comprises a respective protection zone for the given UE.

Example 5 includes the system of Example 4, wherein the system is configured to define at least one of a maximum size of the respective first set of remote units for each UE and a maximum size of the respective second set of remote units for each UE.

Example 6 includes the system of Example 5, wherein the system is configured to determine, for each UE, a respective set of signal reception characteristics for the remote units.

Example 7 includes the system of Example 6, wherein the respective set of signal reception characteristics for the remote units determined for each UE comprises a respective signature vector for that UE.

Example 8 includes the system of Example 7, wherein each UE has an associated respective total simulcast zone power calculated by summing the respective signal reception metrics determined for that UE corresponding to the remote units included in the respective simulcast zone for that UE; wherein each UE has an associated respective total available power calculated by summing the respective signal reception metrics determined for that UE corresponding to all of the remote units; wherein the system is configured to determine the respective simulcast zone for each UE by: sorting the remote units based on the respective corresponding signal reception metrics determined for that UE in descending order from strongest power to weakest power; and starting with a respective empty simulcast zone for that UE, adding, to the respective simulcast zone for that UE, successive remote units from the descending order until the total simulcast zone power calculated for that UE is within a threshold amount of the respective total available power calculated for that UE or until the number of remote units included in the respective simulcast zone for that UE is equal to a predetermined simulcast zone cap.

Example 9 includes the system of any of Examples 6-8, wherein the system is configured to determine, for each UE, the respective set of signal reception characteristics for the remote units on at least one of: signal reception metrics determined at the remote units based on one or more uplink transmissions made by that UE; and signal reception metrics determined at that UE based on one or more downlink transmissions made from the remote units.

Example 10 includes the system of any of Examples 6-9, wherein each UE has an associated respective remaining available power calculated by summing the respective signal reception metrics determined for that UE corresponding to the remote units not included in the protection zone for that UE; wherein the system is configured to determine, for each UE, the respective protection zone by: sorting the remote units based on the respective corresponding signal reception metrics determined for that UE in descending order from strongest power to weakest power; and starting with an empty protection zone, adding to the respective protection zone for that UE the remote units included in the respective simulcast zone for that UE and, from the remaining remote units not included in the respective protection zone for that UE, successive remotes unit in the descending order until the ratio of the respective total simulcast zone power for that UE and the respective remaining available power for that UE exceeds a predetermined threshold value or until the total number of remote units included in the respective protection zone for that UE equals a predetermined protection zone cap.

Example 11 includes the system of any of Examples 1-10, wherein the fronthaul network comprises an Ethernet network.

Example 12 includes the system of any of Examples 1-11, wherein the distributed unit comprise an Open Radio Access Network (O-RAN) distributed unit and the remote units comprise O-RAN remote units.

Example 13 includes the system of any of Examples 1-12, wherein one or more of the remote units is located remotely from the distributed unit.

Example 14 includes the system of any of Examples 1-13, wherein one or more of the remote units is located remotely from at least one other remote unit.

Example 15 includes a method of communicating downlink fronthaul data in a system comprising a distributed unit to communicatively couple the system to a core network and a plurality of remote units to wirelessly transmit and receive radio frequency signals to and from user equipment (UE) using a wireless interface, each of the remote units associated with a respective set of antennas, wherein the distributed unit is communicatively coupled to the plurality of remote units over a fronthaul network, the method comprising doing the following for each UE: determining a respective first set of remote units from which to wirelessly transmit user data to that UE; determining a respective second set of remote units that are not used to wirelessly transmit user data to any other UE while user data is being wirelessly transmitted to that UE, wherein the respective second set of remote units for that UE includes the first set of remote units for that UE; transmitting respective downlink fronthaul data for that UE over the fronthaul network to only the remote units included in the respective first set of remote units for that UE; and wirelessly transmitting respective user data to that UE using the respective first set of remote units for that UE, wherein no remote unit included in the respective second set of remote units for that UE is used to wirelessly transmit user data while wirelessly transmitting to that UE.

Example 16 includes the method of Example 15, wherein, for each UE, wirelessly transmitting the respective user data to that UE using the respective first set of remote units for that UE comprises using unicast transmission to transmit the respective downlink fronthaul data for that UE over the fronthaul network to only the remote units included in the respective first set of remote units for that UE.

Example 17 includes the method of any of Examples 15-16, further comprising permitting multiple UEs to be scheduled for different downlink user data intended for each of the multiple UEs to be simultaneously wirelessly transmitted to the multiple UEs during one or more physical resource blocks in situations where: the first set of remote units for each of said multiple UEs does not intersect with the second set of remote units for any other of said multiple UEs; and the second set of remote units for each of said multiple UEs does not intersect with the first set of remote units for any other of said multiple UEs.

Example 18 includes the method of any of Examples 15-17, wherein the first set of remote units for each UE comprises a simulcast zone for each UE and wherein the second set of remote units for each UE comprises a protection zone for each UE.

Example 19 includes the method of any of Examples 15-16, wherein the system is configured to define at least one of a maximum size of the first set of remote units for each UE and a maximum size of the second set of remote units for each UE.

Example 20 includes the method of Example 19, wherein the system is configured to determine, for each remote unit, associated one or more signal reception characteristics for that UE.

Example 21 includes the method of Example 20, wherein the associated one or more signal reception characteristics for each UE determined for the remote units comprise a signature vector for that UE.

Example 22 includes the method of Example 21, wherein each UE has an associated respective total simulcast zone power calculated by summing the respective signal reception metrics determined for that UE corresponding to the remote units included in the respective simulcast zone for that UE; wherein each UE has an associated respective total available power calculated by summing the respective signal reception metrics determined for that UE corresponding to all of the remote units; wherein determining the respective simulcast zone for each UE comprises: sorting the remote units based on the respective corresponding signal reception metrics determined for that UE in descending order from strongest power to weakest power; and starting with a respective empty simulcast zone for that UE, adding, to the respective simulcast zone for that UE, successive remote units from the descending order until the total simulcast zone power calculated for that UE is within a threshold amount of the respective total available power calculated for that UE or until the number of remote units included in the respective simulcast zone for that UE is equal to a predetermined simulcast zone cap.

Example 23 includes the method of any of Examples 20-22, wherein the system is configured to determine, for each UE, the respective set of signal reception characteristics for the remote units on at least one of: signal reception metrics determined at the remote units based on one or more uplink transmissions made by that UE; and signal reception metrics determined at that UE based on one or more downlink transmissions made from the remote units.

Example 24 includes the method of any of Examples 20-23, wherein each UE has an associated respective remaining available power calculated by summing the respective signal reception metrics determined for that UE corresponding to the remote units not included in the protection zone for that UE; wherein determining, for each UE, the respective protection zone comprises: sorting the remote units based on the respective corresponding signal reception metrics determined for that UE in descending order from strongest power to weakest power; and starting with an empty protection zone, adding to the respective protection zone for that UE the remote units included in the respective simulcast zone for that UE and, from the remaining remote units not included in the respective protection zone for that UE, successive remotes unit in the descending order until the ratio of the respective total simulcast zone power for that UE and the respective remaining available power for that UE exceeds a predetermined threshold value or until the total number of remote units included in the respective protection zone for that UE equals a predetermined protection zone cap.

Example 25 includes the method of any of Examples 15-24, wherein one or more of the remote units is located remotely from the distributed unit.

Example 26 includes the method of any of Examples 15-25, wherein one or more of the remote units is located remotely from at least one other remote unit.

What is claimed is:

1. A system comprising:
a distributed unit to communicatively couple the system to a core network; and
a plurality of remote units to wirelessly transmit and receive radio frequency signals to and from user equipment (UE) using a wireless interface, each of the remote units associated with a respective set of antennas;
wherein the distributed unit is communicatively coupled to the plurality of remote units over a fronthaul network;
wherein the distributed unit is configured to do the following for each UE:
determine a respective first set of remote units from which to wirelessly transmit user data to that UE;
determine a respective second set of remote units that are not used to wirelessly transmit user data to any other UE while user data is being wirelessly transmitted to that UE, wherein the respective second set of remote units for that UE includes the respective first set of remote units for that UE;
transmit respective downlink fronthaul data for that UE over the fronthaul network to only the remote units included in the respective first set of remote units for that UE; and
wirelessly transmit respective user data to that UE using the respective first set of remote units for that UE, wherein no remote unit included in the respective second set of remote units for that UE is used to wirelessly transmit user data while wirelessly transmitting to that UE.

2. The system of claim 1, wherein the distributed unit is configured to do the following for each UE: use unicast transmission to transmit the respective downlink fronthaul data for that UE over the fronthaul network to only the remote units included in the respective first set of remote units for that UE.

3. The system of claim 1, wherein the system is configured to permit respective downlink user data intended for each of multiple UEs to be simultaneously wirelessly transmitted to the multiple UEs during one or more physical resource blocks in situations where:
the first set of remote units for each of said multiple UEs does not intersect with the second set of remote units for any other of said multiple UEs; and
the second set of remote units for each of said multiple UEs does not intersect with the first set of remote units for any other of said multiple UEs.

4. The system of claim 1, wherein the respective first set of remote units for a given UE comprises a respective simulcast zone for the given UE and wherein the respective second set of remote units for the given UE comprises a respective protection zone for the given UE.

5. The system of claim 4, wherein the system is configured to define at least one of a maximum size of the respective first set of remote units for each UE and a maximum size of the respective second set of remote units for each UE.

6. The system of claim 5, wherein the system is configured to determine, for each UE, a respective set of signal reception characteristics for the remote units.

7. The system of claim 6, wherein the respective set of signal reception characteristics for the remote units determined for each UE comprises a respective signature vector for that U E.

8. The system of claim 7, wherein each UE has an associated respective total simulcast zone power calculated by summing the respective signal reception metrics determined for that UE corresponding to the remote units included in the respective simulcast zone for that UE;
wherein each UE has an associated respective total available power calculated by summing the respective signal reception metrics determined for that UE corresponding to all of the remote units;
wherein the system is configured to determine the respective simulcast zone for each UE by:
sorting the remote units based on the respective corresponding signal reception metrics determined for that UE in descending order from strongest power to weakest power; and
starting with a respective empty simulcast zone for that UE, adding, to the respective simulcast zone for that UE, successive remote units from the descending order until the total simulcast zone power calculated for that UE is within a threshold amount of the respective total available power calculated for that UE or until the number of remote units included in the respective simulcast zone for that UE is equal to a predetermined simulcast zone cap.

9. The system of claim 6, wherein the system is configured to determine, for each UE, the respective set of signal reception characteristics for the remote units on at least one of:
signal reception metrics determined at the remote units based on one or more uplink transmissions made by that UE; and
signal reception metrics determined at that UE based on one or more downlink transmissions made from the remote units.

10. The system of claim 6, wherein each UE has an associated respective remaining available power calculated by summing the respective signal reception metrics determined for that UE corresponding to the remote units not included in the protection zone for that UE;
wherein the system is configured to determine, for each UE, the respective protection zone by:
sorting the remote units based on the respective corresponding signal reception metrics determined for that UE in descending order from strongest power to weakest power; and
starting with an empty protection zone, adding to the respective protection zone for that UE the remote units included in the respective simulcast zone for that UE and, from the remaining remote units not included in the respective protection zone for that UE, successive remotes unit in the descending order until the ratio of the respective total simulcast zone power for that UE and the respective remaining available power for that UE exceeds a predetermined threshold value or until the total number of remote units included in the respective protection zone for that UE equals a predetermined protection zone cap.

11. The system of claim 1, wherein the fronthaul network comprises an Ethernet network.

12. The system of claim 1, wherein the distributed unit comprise an Open Radio Access Network (O-RAN) distributed unit and the remote units comprise O-RAN remote units.

13. The system of claim 1, wherein one or more of the remote units is located remotely from the distributed unit.

14. The system of claim 1, wherein one or more of the remote units is located remotely from at least one other remote unit.

15. A method of communicating downlink fronthaul data in a system comprising a distributed unit to communicatively couple the system to a core network and a plurality of remote units to wirelessly transmit and receive radio frequency signals to and from user equipment (UE) using a wireless interface, each of the remote units associated with a respective set of antennas, wherein the distributed unit is communicatively coupled to the plurality of remote units over a fronthaul network, the method comprising doing the following for each UE:
determining a respective first set of remote units from which to wirelessly transmit user data to that UE;
determining a respective second set of remote units that are not used to wirelessly transmit user data to any other UE while user data is being wirelessly transmitted to that UE, wherein the respective second set of remote units for that UE includes the first set of remote units for that UE;
transmitting respective downlink fronthaul data for that UE over the fronthaul network to only the remote units included in the respective first set of remote units for that UE; and
wirelessly transmitting respective user data to that UE using the respective first set of remote units for that UE, wherein no remote unit included in the respective second set of remote units for that UE is used to wirelessly transmit user data while wirelessly transmitting to that UE.

16. The method of claim 15, wherein, for each UE, wirelessly transmitting the respective user data to that UE using the respective first set of remote units for that UE comprises using unicast transmission to transmit the respective downlink fronthaul data for that UE over the fronthaul network to only the remote units included in the respective first set of remote units for that UE.

17. The method of claim 15, further comprising permitting multiple UEs to be scheduled for different downlink user data intended for each of the multiple UEs to be simultaneously wirelessly transmitted to the multiple UEs during one or more physical resource blocks in situations where:
the first set of remote units for each of said multiple UEs does not intersect with the second set of remote units for any other of said multiple UEs; and
the second set of remote units for each of said multiple UEs does not intersect with the first set of remote units for any other of said multiple UEs.

18. The method of claim 15, wherein the first set of remote units for each UE comprises a simulcast zone for each UE and wherein the second set of remote units for each UE comprises a protection zone for each UE.

19. The method of claim 15, wherein the system is configured to define at least one of a maximum size of the first set of remote units for each UE and a maximum size of the second set of remote units for each UE.

20. The method of claim 19, wherein the system is configured to determine, for each remote unit, associated one or more signal reception characteristics for that UE.

21. The method of claim 20, wherein the associated one or more signal reception characteristics for each UE determined for the remote units comprise a signature vector for that UE.

22. The method of claim 21, wherein each UE has an associated respective total simulcast zone power calculated by summing the respective signal reception metrics determined for that UE corresponding to the remote units included in the respective simulcast zone for that UE;
wherein each UE has an associated respective total available power calculated by summing the respective signal reception metrics determined for that UE corresponding to all of the remote units;
wherein determining the respective simulcast zone for each UE comprises:
sorting the remote units based on the respective corresponding signal reception metrics determined for that UE in descending order from strongest power to weakest power; and
starting with a respective empty simulcast zone for that UE, adding, to the respective simulcast zone for that UE, successive remote units from the descending order until the total simulcast zone power calculated for that UE is within a threshold amount of the respective total available power calculated for that UE or until the number of remote units included in the respective simulcast zone for that UE is equal to a predetermined simulcast zone cap.

23. The method of claim 20, wherein the system is configured to determine, for each UE, the respective set of signal reception characteristics for the remote units on at least one of:
signal reception metrics determined at the remote units based on one or more uplink transmissions made by that UE; and
signal reception metrics determined at that UE based on one or more downlink transmissions made from the remote units.

24. The method of claim 20, wherein each UE has an associated respective remaining available power calculated by summing the respective signal reception metrics determined for that UE corresponding to the remote units not included in the protection zone for that UE;
wherein determining, for each UE, the respective protection zone comprises:
sorting the remote units based on the respective corresponding signal reception metrics determined for that UE in descending order from strongest power to weakest power; and
starting with an empty protection zone, adding to the respective protection zone for that UE the remote units included in the respective simulcast zone for that UE and, from the remaining remote units not included in the respective protection zone for that UE, successive remotes unit in the descending order until the ratio of the respective total simulcast zone power for that UE and the respective remaining available power for that UE exceeds a predetermined threshold value or until the total number of remote units included in the respective protection zone for that UE equals a predetermined protection zone cap.

25. The method of claim 15, wherein one or more of the remote units is located remotely from the distributed unit.

26. The method of claim 15, wherein one or more of the remote units is located remotely from at least one other remote unit.
